(19) United States
(12) Patent Application Publication
(10) Pub. No.: US 2007/0018005 A1
(43) Pub. Date: Jan. 25, 2007

(54) Building humidity control process

(76) Inventors: Roland H. Isaacson, Dunnellon, FL (US); Albert L. Saari, Plymouth, MN (US)

Correspondence Address: Friederichs Law Firm, 6421 Kurtz Lane, Eden Prairie, MN, 55346-1609, US

(21) Appl. No.: 11/496,295

(22) Filed: Jul. 31, 2006

Related U.S. Application Data
(63) Continuation of application No. 10/435,523, filed on May 9, 2003, now abandoned.

(51) Int. Cl. F24F 3/14; G05D 22/02

(52) U.S. Cl. 236/44 A

(57) ABSTRACT

A process for reducing the relative humidity in a living area comprising application of three circuits of air flow to the living area, the first circuit being for the purpose of cooling the air, the second circuit being for the purpose of drying the air and the third circuit includes passing unsaturated, heated air through the salt to extract the moisture from the salt.

### FIELD OF THE PRESENT INVENTION

The present invention relates to lowering the relative humidity in a desired space.

### SUMMARY OF THE PRESENT INVENTION

The disclosed process exploits two well-known principles in a unique way: 1. Raoult's Law and Henry's Law define and explain the observation that the relative humidity (RH−partial pressure of water divided by the partial pressure of water at a specified temperature×100) of a saturated solution of a solute in water is an inherent characteristic of that solute and; (2) the relative humidity of air at a constant moisture content (Absolute Humidity) is dramatically affected by changes in temperature.

The process for reducing the relative humidity in a building comprises contacting cooled air with endothermic salt of low water content that removes some of the residual water from cooled air distributed in the house. The treated air is returned to the living space and the salt is restored by exhaust heat from a mechanical air conditioner. The returning air to the house should be preferably at below 50% RH after getting to the control temperature of the space. The first circuit comprises the passing of said air flow over a plurality of coils over a series of refrigeration or cooling coils, heat exchangers or the like if needed. The second circuit being passing the air flow through a bed of salt to reduce the relative humidity; and the third circuit employed to regenerated the salt bed by removing moisture from the salt with waste heat or low value, waste heat.

### UTILITY AND PURPOSE OF THIS INVENTION

It is important to maintain the relative humidity below about 50% in a living space. The growth of mold or development of mildew is inhibited in floor coverings and clothing under these conditions. The infestation by dust mites and similar microscopic fauna is controlled as well.

Most notable is the Psychometric observations show that higher temperatures are accepted in a living space providing the relative humidity is less than about 50%. Temperatures over 100 degrees in the shade are acceptable providing the relative humidity is less than 10% as in a desert or dry Finnish style sauna. Home temperatures above 80 degrees are tolerable at relative humidities about 50% but not at 60%. The ability to hold temperatures as little as 5 degrees higher can produce substantial energy savings, especially in warmer climates.

Recently installed air conditioning systems with mandated environment-friendly refrigerants operated with warmer coils, hence are less effective at removing moisture from the air. Consequently, living spaces are less comfortable unless the temperature is kept relatively low. Therefore, the practice of the teaching of this filing can result in comfort with significant cost savings by reducing the relative humidity in a living space with low operating costs.

### DEFINITIONS

1. Living area is any space such as a house, an apartment or a room in a house, office building or any space that a humidity change is desired.

2. RH is relative humidity.

3. Salt is defined as the combination of a metallic cation and a variety of anions including Sodium Chloride, Potassium Chloride, Calcium Bromide, common commercial salt pellets, rock salt or salt in an open cell substance such as florists foam (urethane foam) or encased in a plastic or like material with a moisture vapor transmission rate such as styrene or urethane based co-polymers.

4. Heat Exchanger is any air to air, any liquid coil to liquid coil without fins, or liquid to vapor or similar device suitable for transferring thermal energy between fluids. Each of these can be either continuous or interval types of heat exchanger.

5. Sink is either a Warm Heat Sink or Cool Heat Sink. The sink in circuit 2 would be a cool heat sink during removal of moisture from the air and would be a warm heat sink in moisture removal from the salt. The sink in circuit 1 should be a cool sink and the sink in circuit 3 would be a warm sink, if needed.

### DETAILED DISCLOSURE

The present invention relates to a process for removing moisture from air, a process for reducing the relative humidity in a house. Such air typically having an RH of over 50%. The process preferably includes three circuits of air flow to the house to help remove the moisture from the air. The RH is raised to 70 to 100%. In the first circuit which may include a heat sink such as an air conditioner with a plurality of refrigerator coils or heat exchanger then it is passed through a bed of salt with or without a heat exchanger.

The second circuit being for the purpose of drying the air. The second circuit being passing said air flow through a bed of salt to reduce the moisture in the air, hence lowering the RH in the desired space. The salt may be any endothermic salt, such as halogen salt. The bed of salt is preferably NaCl (Sodium Chloride). The dried air is fed into the desired space.

The third circuit may include passing unsaturated heated air through the salt to extract the moisture from said salt and deposit the heated air containing excess moisture outside of the house.

The third circuit may be heated by heat exchangers, solar, heat pumps, air conditioners directly or the heat of the exterior fans, gas, electric, phase change material or another air heating method.

This can be done before the entry of the air to the system or diverting the air through a warm heat sink at the place of the cool heat sink position when moisture is being removed from the salt.

The first circuit is the circuit that prepares the air to have the moisture removed from it by the second circuit. The third circuit prepares the air that goes into the second circuit to remove the moisture from the salt.

The first circuit gets the air from outdoors or the space that is to have the moisture removed from it. To do this it raises the relative humidity to a high 100% RH. Cooling is often needed to raise the relative humidity by a heat exchanger, heat sink, air conditioner or like apparatus.

The second circuit is a bed of salt which can have a heat exchanger to enhance the removal of moisture from the air or the salt, depending on the cycle in which the operator is in. A heat sink (hot and cold) can also be added to enhance the removal of moisture from the air or salt as desired which then exhausts the air to the desired place.

The third circuit can use any low relative air available which would probably be outdoors of the formerly dried air from the dried space. This air can be processed to even lower RH by heat exchangers, solar energy coil from heat pump as air conditioners or like. The air received back from the second circuit probably would be exhausted outdoors.

By cycling the first and third circuit in delivering the air to the second circuit, the RH will be lowered in the space desired with minimal use of energy.

The use of more than one second circuit will enhance the effectiveness of operation with each first and second circuit.

The first circuit is the circuit that prepares the air to have the moisture removed from it by the second circuit. The third circuit prepares the air that goes into the second circuit to remove the moisture from the salt.

The first circuit gets the air from outdoors or the space that is to have the moisture removed from it. To do this, it raises the relative humidity to a high of 100% RH. Cooling is needed to raise the relative humidity by a heat exchanger, heat sink, air conditioner or like apparatus.

The second circuit is a bed of salt which can have a heat exchanger to enhance the removal of moisture from the air or the salt, depending on the cycle in which the operator is in. A heat sink (hot and cold) can also be added to enhance the removal of moisture from the air or salt as desired which then exhausts the air.

The third circuit can use any low relative air available which would probably be outdoors or the formerly dried air from the dried space. This air can be processed to even lower RH by a heat exchanger, solar energy coil from a heat pump as air conditioners or the like. The air received back from the second circuit probably would be exhausted outdoors.

By cycling the first and third circuit in delivering the air to the second circuit, the RH will be lowered in the space desired with minimal use of energy.

The use of more than one second circuit will enhance the effectiveness of operation with each first and second circuit.

The second circuit can be used before air conditioning to increase efficiency then another second circuit can be used after the air conditioner as needed.

What is claimed is:

1. A process for controlling relative humidity in a living area comprising:
passing moist air including the moisture through a cool heat sink, if needed to lower the temperature of the air passing into the living area;
passing the cooled air through a salt to remove much of the moisture in order to produce cooled dried air;
returning the dehydrated air to the living area directly through an air conditioner.

2. A process for reducing the relative humidity in a living area by contacting said air with an alkali metal halide, producing air with reduced water content and returning said air to said living area.

3. The process of claim 2 wherein the alkali metal halide is Sodium Chloride.

4. A process for reducing the relative humidity in a living area comprising applying three circuits of air flow to said living area, said first circuit being for the purpose of cooling the air if needed, said second circuit being for the purpose of drying the air, the first circuit comprising passing said air flow over a plurality of coils over a series of refrigeration coils, said second circuit being passing said air flow through a bed of salt to reduce the moisture in the air; and said third circuit comprising passing unsaturated heated air through said salt to extract said moisture from said salt and deposit said heated air outside of said living area.

5. The process of claim 1, wherein the process includes a low RH air that is being exhausted can also be used to remove the moisture from the salt.

6. The process of claim 5, wherein the process includes the cycle where low RH air being exhausted is heated to cause a greater affect on removing moisture.

7. The process of claim 5, wherein the process includes the step that the air that has removed moisture from the salt is exhausted out of doors.

8. The process of claim 7, wherein the process includes by repeating the process over and over the moisture can be removed as necessitated by certain situations.

9. The process of claim 8, wherein the endothermic salt employed in the process is Sodium Chloride (NaCl).

10. The process of claim 9, wherein the process includes using low energy exothermic salt with the same process when circumstances result in saving energy and/or other costs or a need for another range of RH values.

11. The process of claim 2, wherein the process includes a low RH air that is being exhausted can also be used to remove the moisture from the salt.

12. The process of claim 11, wherein the process includes the air that has the added moisture from the salt is exhausted outdoors.

13. The process of claim 12, wherein the process includes the step by repeating the above process over and over the moisture can be removed as per the need of the situation.

14. The process of claim 2, wherein the process includes by using an endothermic salt is selected from the consisting of sodium chloride, potassium chloride or sodium bromide.

15. The process of claim 2, wherein the process include using low energy exothermic salt with the same process the saving in energy would still be substantial when RH requirements for the living space are unusual.

16. The process of claim 2, wherein the process includes using low energy exothermic salt with the same process the saving in energy would still be large if that is the range needed.

17. The process of claim 2, wherein said circuits two and three are repeated.

18. The process of claim 2, wherein salt circuit uses a heat exchanger in parallel with it to lower temperature and increase and hold RH as moisture is removed from air.

19. The process of claim 2, wherein the same heat exchanger is used to raise temperature and decrease RH in removing moisture from salt.

20. The process of claim 2, wherein a cool heat sink is used to enhance the temperature change.

21. The process of claim 5, wherein, a warm heat sink is used to enhance the temperature change.

22. The process of claim 6, wherein, a warm heat sink is used to enhance the temperature change.

24. The process of claim 19, wherein, a plurality of heat exchangers at intervals in series.

25. The process of claim 19, wherein, the airstream is passed trough said bed of salt prior to cooling.
